(19) United States
(12) Patent Application Publication
(10) Pub. No.: US 2025/0333311 A1
(43) Pub. Date: Oct. 30, 2025

(54) NEGATIVE ELECTRODE MATERIAL, NEGATIVE ELECTRODE PLATE, AND BATTERY

(71) Applicant: ZHUHAI COSMX BATTERY CO., LTD., Zhuhai (CN)

(72) Inventors: Hui WANG, Zhuhai (CN); Jiachen XUE, Zhuhai (CN); Hongsheng FAN, Zhuhai (CN); Ruinian LI, Zhuhai (CN); Chunyang LIU, Zhuhai (CN); Suli LI, Zhuhai (CN)

(73) Assignee: ZHUHAI COSMX BATTERY CO., LTD., Zhuhai (CN)

(21) Appl. No.: 19/263,870

(22) Filed: Jul. 9, 2025

Related U.S. Application Data
(63) Continuation-in-part of application No. PCT/CN2024/072985, filed on Jan. 18, 2024.

(30) Foreign Application Priority Data
Mar. 4, 2023 (CN) 202310199623.5

(51) Int. Cl. C01B 32/05; H01M 10/0525

(52) U.S. Cl. CPC C01B 32/05; H01M 10/0525; C01P 2002/08; C01P 2002/72; C01P 2002/88; C01P 2004/51; C01P 2004/61; C01P 2004/86; C01P 2006/12; C01P 2006/16; C01P 2006/40

(57) ABSTRACT

A negative electrode material has a core-shell structure. The shell includes a carbon layer, the core includes porous carbon and silicon particles distributed in the pores of the porous carbon, and the negative electrode material has a weight-gain peak between 400° C. and 900° C. on a derivative thermogravimetric curve of the negative electrode material.

### CROSS-REFERENCE TO RELATED APPLICATIONS

The present disclosure is a continuations-in-part of International Application No. PCT/CN2024/072985, filed on Jan. 18, 2024, which claims priority to Chinese Application No. CN202310199623.5, filed on Mar. 4, 2023. The contents of the above applications are incorporated herein by reference.

### TECHNICAL FIELD

The present disclosure relates to the field of battery technology, which specifically relates to a negative electrode material, and a negative electrode plate and a battery both including the negative electrode material.

### BACKGROUND

The rapid development in new energy technology fields such as electronic devices, electric vehicles, and energy storage power stations has put forward increasingly higher requirements for the energy density of lithium-ion battery. In the current material system of lithium-ion battery, the negative electrode uses graphite material. However, with the continuous progress and improvement of process technologies, the actual performance of graphite material has gradually approached its theoretical limit, making it difficult to have further development. In the exploration of the next-generation high-energy-density battery material system, silicon-based negative electrode has become a key research object due to its high theoretical capacity being ten times that of graphite negative electrode. However, the volume expansion rate of silicon-based negative electrode after full lithium intercalation exceeds 300%, which easily causes problems such as particle pulverization, damage to the electrode structure, and repeated rupture and growth of the surface Solid Electrolyte Interphase (SEI) film, severely restricting the practical application of silicon-based negative electrode. In addition, silicon is a semiconductor material with low electronic and ionic conductivities, and its rate performance is poor.

To address the above problems, the industry has proposed coating a carbon layer on the surface of silicon particles to improve the electrical conductivity of the material and prevent direct contact between the electrolyte solution and silicon particles. However, for conventionally structured carbon-coated silicon-based materials, their inner cores still have a large volume expansion rate after lithium intercalation, and the surface carbon layer will deform together when the inner core expands, easily causing the carbon layer to crack or peel off from the surface of the inner core, thus failing to effectively inhibit side reactions occurring after contact between the electrolyte solution and silicon particles in a long term.

Therefore, it is very important to invent a battery with better rate performance, higher cycling capacity retention rate, and lower expansion rate.

### SUMMARY

Objectives of the present disclosure are to address the above-mentioned problems existing in the conventional technology, and provide a negative electrode material, as well as a negative electrode plate and a battery comprising the negative electrode material. The negative electrode material of the present disclosure has high structural stability and can provide a buffer space for the expansion of silicon particles; the negative electrode plate obtained from the negative electrode material has high specific capacity and high initial coulombic efficiency; and the battery obtained from the negative electrode plate has good rate performance, high cycling capacity retention rate, and low expansion rate.

It has been found through research that by improving the structural stability of silicon particles, the specific capacity of the negative electrode plate and the initial coulombic efficiency can be enhanced, thereby improving the rate performance and cycling capacity retention rate of the battery and reducing the expansion rate of the battery.

Through further in-depth research, it has been found that in order to improve the structural stability of silicon particles, a specific structure can be used to provide a buffer space for the volume expansion of silicon particles, reduce the overall expansion rate of the material, and thus improve the specific capacity and initial coulombic efficiency of the negative electrode plate, as well as improve the rate performance and cycling capacity retention rate of the battery and reduce the expansion rate of the battery. The present disclosure provides a specific structure that can provide a buffer space for the volume expansion of silicon particles.

To achieve the above objectives, the present disclosure provides, in a first aspect, a negative electrode material. The negative electrode material has a core-shell structure, where the shell of the negative electrode material includes a carbon layer, the core of the negative electrode material includes porous carbon and silicon particles distributed in the pores of the porous carbon, and the negative electrode material has a weight-gain peak between 400° C. and 900° C. on its derivative thermogravimetric curve.

In a second aspect, the present disclosure provides a negative electrode plate, which includes the negative electrode material according to the first aspect of the present disclosure.

In a third aspect, the present disclosure provides a battery, which includes the negative electrode material according to the first aspect of the present disclosure.

Through the above technical solutions, the present disclosure has at least the following advantages compared with the conventional technology:
the negative electrode material of the present disclosure has good structural stability;
the negative electrode plate of the present disclosure has high specific capacity;
the negative electrode plate of the present disclosure has high initial coulombic efficiency;
the battery of the present disclosure has good rate performance;
the battery of the present disclosure has high cycling capacity retention rate; and
the battery of the present disclosure has low volume expansion rate.

Other features and advantages of the present disclosure will be described in detail in the subsequent specific implementation manner section.

### BRIEF DESCRIPTION OF THE DRAWINGS

FIG. 1 shows an X-ray powder diffraction (XRD) pattern of the negative electrode material according to an embodiment of the present disclosure.

FIG. 2 shows a thermogravimetric (TG) curve and a derivative thermogravimetric (DTG) curve of the negative electrode material according to an embodiment of the present disclosure.

FIG. 3 shows a thermogravimetric (TG) curve and a derivative thermogravimetric (DTG) curve of the negative electrode material of Example 1 of the present disclosure.

FIG. 4 shows discharge curves of batteries prepared from the negative electrode materials of Example 1 and Comparative Example 1 of the present disclosure at different rates.

### DETAILED DESCRIPTIONS OF THE EMBODIMENTS

The specific embodiments of the present disclosure are described in detail below. It should be understood that the specific embodiments described herein are only used to illustrate and explain the present disclosure, and are not intended to limit the present disclosure.

The first aspect of the present disclosure provides a negative electrode material, where the negative electrode material has a core-shell structure, the shell of the negative electrode material includes a carbon layer, and the core of the negative electrode material includes porous carbon and silicon particle distributed in the pores of the porous carbon, and the negative electrode material has a weight-gain peak between 400° C. and 900° C. on its derivative thermogravimetric curve.

Existing silicon-carbon composite materials often form a carbon coating layer on the surface of silicon particles by means of chemical vapor deposition or polymer pyrolysis. However, even if the carbon coating layer formed by this method is initially dense, during the expansion of silicon particles, the carbon coating layer will expand together with the inner core of the silicon particles, which easily causes the carbon coating layer to detach or peel off from the surface of the silicon particles. This leads to direct contact between the electrolyte solution and the silicon particles. The electrolyte solution is reduced on the surface of the silicon particles to form a passivation film. With the continuous progress of cycling, the passivation film will also undergo repeated rupture and growth as the inner core of the silicon particles continuously expands and contracts. This consumes active lithium in the battery and generates additional gas, thereby causing continuous decay of battery capacity and continuous increase in thickness.

Through research, it has been found that by depositing silicon particles in the pores of porous carbon to form silicon-carbon composite particles, the unfilled voids in the porous carbon can be used to buffer the volume expansion of the silicon particles during lithium intercalation. This reduces the overall volume change rate of the silicon-carbon composite particles during deintercalation and intercalation of lithium, improves the structural stability of the silicon-carbon composite particles, and avoids the problem of failure of the surface coating layer caused by excessive expansion of the silicon particles. Moreover, by forming a dense carbon layer on the surface of the silicon-carbon composite particles, the reduction and decomposition of the electrolyte solution can be effectively reduced, thereby further improving the cycling stability of the battery.

In the present disclosure, by adopting the above-mentioned manner to improve the structural stability of the negative electrode material, the negative electrode material can already achieve better stability than the conventional technology. In order to further enhance the effect, one or more technical features can be further optimized.

The carbon layer may partially or entirely coat the outer surface of the silicon-carbon composite particles. When the carbon layer partially coats the surface of the silicon-carbon composite particles, the carbon layer can at least coat the pores where silicon particles are distributed, so that the carbon layer as the shell can prevent direct contact between the electrolyte solution and the silicon particles, reduce the reduction and decomposition of the electrolyte solution, and further improve the cycling stability of the battery.

The negative electrode material has a weight-gain peak in the derivative thermogravimetric (DTG) curve between 400° C. and 900° C. (e.g., 400° C., 450° C., 500° C., 550° C., 600° C., 650° C., 700° C., 750° C., 800° C., 850° C., 900° C.) in the thermogravimetric analysis (TGA) result with air or oxygen as the atmosphere. For example, as shown in FIG. 2, it can be seen that the derivative thermogravimetric (DTG) curve has a weight-gain peak between 400° C.-900° C.

In one embodiment, the derivative thermogravimetric curve of the negative electrode material has a weight-gain peak between 400° C. and 900° C. and at least one weight-loss peak (e.g., one weight-loss peak, two weight-loss peaks) in the temperature range lower than the temperature corresponding to the weight-gain peak. The derivative thermogravimetric (DTG) curve is a curve of the first derivative of the thermogravimetric (TG) curve. Both the weight-gain peak and the weight-loss peak exist between 400° C. and 900° C., and the position where the weight-loss peak appears is before the position where the weight-gain peak appears.

In one embodiment, in the thermogravimetric analysis result of the negative electrode material with air or oxygen as the atmosphere, the derivative thermogravimetric (DTG) curve has a weight-gain peak between 400° C. and 900° C. and a weight-loss peak in the temperature range lower than the temperature corresponding to the weight-gain peak.

When the DTG curve of the negative electrode material shows a weight-gain peak between 400° C. and 900° C. under air or oxygen atmosphere, it can effectively improve the stability of the negative electrode material, effectively alleviate the expansion of silicon, reduce the contact reaction with the electrolyte solution, and thus improve the cycling performance of the negative electrode material and reduce the expansion rate.

In one embodiment, the negative electrode material has a weight-gain peak between 400° C. and 900° C. and at least one weight-loss peak (e.g., one weight-loss peak, two weight-loss peaks) in the temperature range lower than the temperature corresponding to the weight-gain peak, which further indicates that the shell of the negative electrode material includes a relatively dense carbon layer. This is because the weight-loss peak may be formed due to the weight loss of the negative electrode material caused by the combustion of the carbon layer in air or oxygen. If there is no carbon layer on the surface or the carbon layer is not dense enough, more oxygen molecules passing through the carbon layer to contact silicon will oxidize silicon before the carbon starts to burn, leading to weight gain, which offsets the weight loss caused by carbon combustion, and thus no weight-loss peak will appear before the weight-gain peak. Therefore, the presence of at least one weight-loss peak (e.g., one weight-loss peak, two weight-loss peaks) in the temperature range lower than the temperature corresponding to the weight-gain peak can effectively improve the stability of silicon, avoid contact between the core of the negative electrode material and the electrolyte, and improve the initial coulombic efficiency of the negative electrode plate.

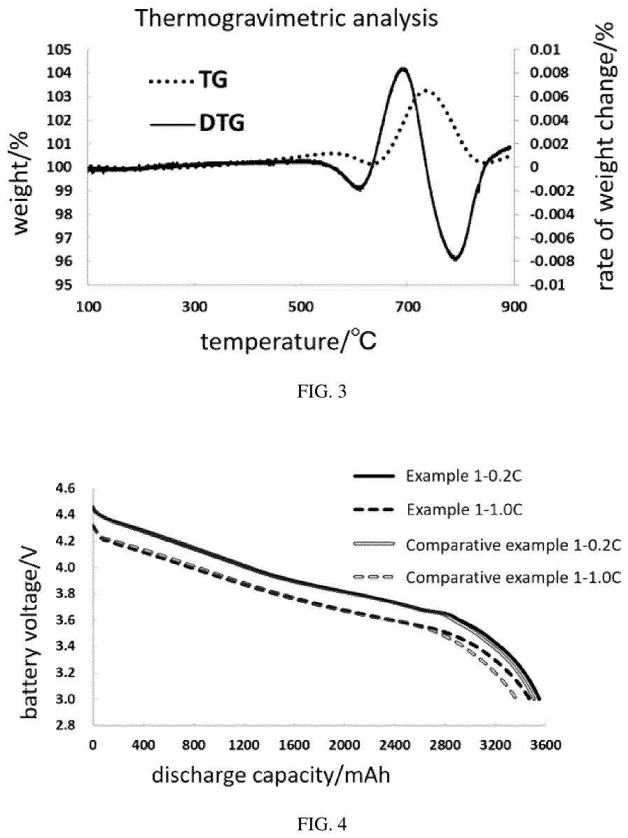

For example, as shown in FIG. 3, it can be seen that the mass change rate of the derivative thermogravimetric (DTG) curve between 400° C.-900° C. constitutes multiple peak shapes, where the peak value of one peak is a positive value greater than zero, indicating that the peak is a weight-gain peak, and there is a peak with a peak value of a negative value less than zero in the temperature range lower than the weight-gain peak, which is a weight-loss peak, indicating that a relatively dense carbon layer exists on the surface of the negative electrode material.

In the present disclosure, the thermogravimetric (TG) curve and derivative thermogravimetric (DTG) curve of the negative electrode material can be tested by thermogravimetric analysis, for example, using a Shimadzu DTG-60 thermogravimetric analyzer. The sample amount for the test is 5 mg, the atmosphere is air or oxygen, the heating rate is 10° C./min, and the test range is 20° C.-900° C.

In one embodiment, the pore size of the porous carbon is less than 10 nm (e.g., 1 nm, 2 nm, 3 nm, 4 nm, 5 nm, 6 nm, 7 nm, 8 nm, 9 nm).

In one embodiment, the pore size of the porous carbon ranges from 1 nm to 5 nm. The pore size of the porous carbon is the most probable pore size.

In the present disclosure, the most probable pore size of the porous carbon can be tested by the following method: the nitrogen adsorption amount of the porous carbon under a pressure of 0.0001 P₀-0.995 P₀ (where P₀ is the saturated vapor pressure of nitrogen at liquid nitrogen temperature (77K)) is measured by the nitrogen static adsorption equilibrium method, and then the pore size-pore volume distribution map of the porous carbon is calculated according to the non-local density functional theory (NLDFT) model. The pore size corresponding to the point with the highest pore volume in this map is the most probable pore size of the porous carbon. For example, the test is carried out using a Micrometrics TriStar II 3020 Surface Area and Porosity System.

In one embodiment, the pore size of the porous carbon is less than 10 nm, and/or the median particle size Dv50 of the silicon particles ranges from 0.1 nm to 10000 nm.

In one embodiment, the median particle size Dv50 of the silicon particles ranges from 0.1 nm to 10000 nm (e.g., 0.1 nm, 0.5 nm, 1 nm, 5 nm, 10 nm, 50 nm, 100 nm, 500 nm, 1000 nm, 5000 nm, 10000 nm).

It should be noted that when the median particle size Dv50 of the silicon particles is larger than the pore size of the porous carbon, the silicon particles can still be distributed in the pores of the porous carbon. Because the pore size of the porous carbon limits the width of the silicon particles, but does not limit the length of the silicon particles. The silicon particles distributed in the pores of the porous carbon may grow into larger rod-like or dendritic shapes along the carbon pores, so the median particle size of the silicon particles may be larger than the pore size of the porous carbon.

In one embodiment, the median particle size Dv50 of the silicon particles ranges from 100 nm to 8000 nm.

In the present disclosure, the median particle size Dv50 of the silicon particles can be tested by the following method: a laser particle size test method is adopted. For example, a Malvern particle size tester is used for measurement, and the test steps are as follows: the silicon-carbon particles are dispersed in deionized water containing a dispersant (such as nonylphenol polyoxyethylene ether, with a content of 0.02 wt %-0.03 wt %), to form a mixture, the mixture is ultrasonically treated for 2 min, and then put into the Malvern particle size tester for testing.

According to a specific embodiment, the pore volume of the porous carbon is greater than 0.3 cm³/g (e.g., 0.4 cm³/g, 0.5 cm³/g, 1 cm³/g, 1.5 cm³/g, 2 cm³/g, 2.5 cm³/g, 3 cm³/g).

In one embodiment, the pore volume of the porous carbon is greater than 0.5 cm³/g.

According to a specific embodiment, in the X-ray powder diffraction (XRD) test of the negative electrode material, there is a diffraction peak in the range of 2θ=28.4°±0.5°, and the full width at half maximum of this diffraction peak, denoted as B in terms of 2θ degrees, satisfies 0.3°≤B≤10°. The full width at half maximum of the diffraction peak represents the peak width at half the height of the diffraction peak.

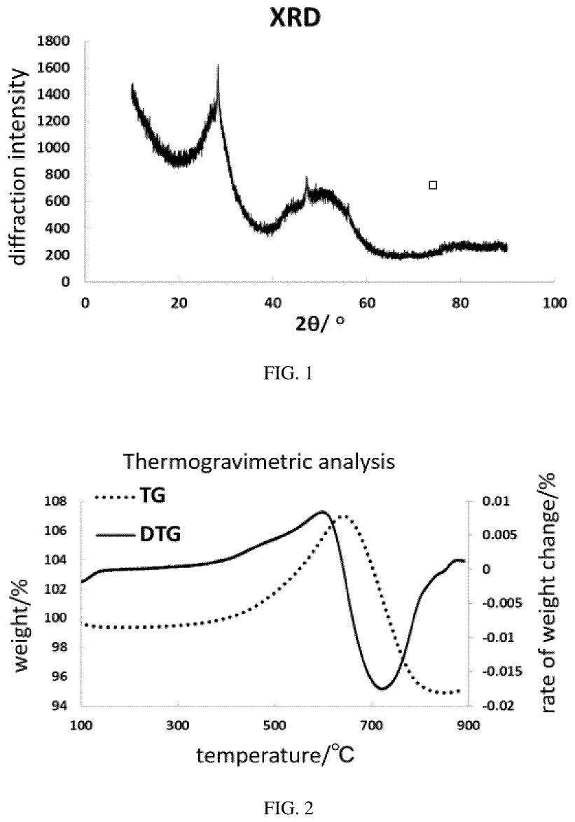

For example, as shown in FIG. 1, it can be seen that there is a diffraction peak in the range of 2θ=28.4°±0.5°. When the negative electrode material has a diffraction peak in the range of 2θ=28.4°±0.5° in the XRD test, it indicates that the negative electrode material contains silicon. When the full width at half maximum B of the diffraction peak satisfies 0.3°≤B≤10°, it indicates that the silicon particles in the negative electrode material have moderate crystallinity and grain size. Moderate crystallinity and grain size enable the negative electrode material to have better lithium ion transport rate and specific capacity. When B<0.3°, it indicates that the silicon particles in the negative electrode material have high crystallinity and large grain size. When the crystallinity of the silicon particles is high, the transport rate of lithium ions in their lattice is relatively slow, and the large silicon grains will have a large volume expansion after lithium intercalation, which is likely to damage the structure of the porous carbon particles. When B>10°, it indicates that the grain size of the silicon particles in the negative electrode material is very small or the silicon content is low. The low packing density of the silicon with small grain size results in a low filling rate of the silicon particles in the limited pores of the porous carbon, leading to a low specific capacity of the negative electrode material.

In one embodiment, B satisfies 0.5°≤B≤6°.

In the present disclosure, the 2θ characteristic diffraction peak is tested by X-ray diffraction (XRD) method, for example, using a Shimadzu XRD-6100 X-ray diffractometer. The sample amount for the testis 0.5 g/cm², using Cu Kα line as the incident X-ray, the working voltage of the X-ray source is 40 kV, the test power is 2 kW, with 2θ as the abscissa (unit: °) and the signal intensity as the ordinate, the test range is 10°-80°, the scanning rate is 4°/min, and the data point interval is 0.02°.

According to a specific embodiment, in the negative electrode material, the ratio x of the weight content of silicon element to the weight content of carbon element satisfies 0.33≤x≤3 (e.g., 0.33, 0.5, 0.8, 1, 1.5, 2, 2.5, 3).

When the ratio x of the weight content of silicon element to the weight content of carbon element in the negative electrode material satisfies 0.33≤x≤3, the negative electrode material achieves a relatively balanced state between high specific capacity and high structural stability. When x<0.33, an insufficient amount of the silicon content in the negative electrode, resulting in a low specific capacity of the negative electrode material, which is difficult to meet the high energy density requirement of lithium-ion batteries. When x>3, an excessive amount of the silicon content in the negative electrode material, the volume change rate of the negative electrode material during lithium deintercalation and intercalation is large, and the structural stability of the particles is low, which is difficult to meet the high cycling stability requirement of lithium-ion batteries.

In one embodiment, in the negative electrode material, the ratio x of the weight content of silicon element to the weight content of carbon element satisfies 0.5≤x≤2.

In the present disclosure, the relative contents of silicon and carbon elements in the negative electrode material can be analyzed by X-ray fluorescence (XRF) or energy-dispersive spectroscopy (EDS), for example, using a Thermo Fisher X-ray fluorescence spectrometer or an Oxford EDS spectrometer.

According to a specific embodiment, the thickness of the carbon layer ranges from 1 nm to 15 nm (e.g., 1 nm, 2 nm, 3 nm, 4 nm, 5 nm, 7 nm, 10 nm, 12 nm, 15 nm). When the thickness of the carbon layer is within the above range, the carbon layer can exhibit stronger electrical conductivity and is not prone to cracking, thereby improving the initial coulombic efficiency of the negative electrode plate. When the thickness of the carbon layer is less than 1 nm, the electrical conductivity of the negative electrode material decreases; when the thickness of the carbon layer is greater than 15 nm, the proportion of carbon in the material is too high, resulting in a low specific capacity of the negative electrode material.

In one embodiment, the thickness of the carbon layer ranges from 2 nm to 10 nm. When the thickness of the carbon layer ranges from 2 nm to 10 nm, the electrical conductivity of the carbon layer can be further enhanced, the carbon layer is less prone to cracking, and a higher specific capacity is achieved simultaneously.

In the present disclosure, the thickness of the carbon layer can be tested by the following method: observing the negative electrode material using a transmission electron microscope, for example, measuring the thickness of the surface carbon layer of negative electrode material particles using a JEOL/JEM-2010-fef transmission electron microscope.

According to a specific embodiment, the median particle size Dv50 of the porous carbon is ranges from 1 μm to 15 μm (e.g., 1 μm, 2 μm, 3 μm, 4 μm, 5 μm, 6 μm, 7 μm, 8 μm, 9 μm, 10 μm, 11 μm, 12 μm, 13 μm, 14 μm, 15 μm).

In one embodiment, the median particle size Dv50 of the porous carbon ranges from 3 μm to 12 μm.

In the present disclosure, the median particle size of the porous carbon can be measured by a laser particle size test method, for example, using a Malvern particle size tester. The test steps are as follows: dispersing the porous carbon in deionized water containing a dispersant (such as nonylphenol polyoxyethylene ether, with a content of 0.02 wt %-0.03 wt %) to form a mixture, subjecting the mixture to ultrasonication for 2 min, and then placing it into the Malvern particle size tester for testing.

In one embodiment, the specific surface area of the porous carbon ranges from 300 m²/g to 1,800 m²/g (300 m²/g, 500 m²/g, 600 m²/g, 700 m²/g, 800 m²/g, 900 m²/g, 1,000 m²/g, 1,100 m²/g, 1,200 m²/g, 1,300 m²/g, 1,400 m²/g, 1,500 m²/g, 1,600 m²/g, 1,800 m²/g).

In one embodiment, the specific surface area of the porous carbon ranges from 500 m²/g to 1,600 m²/g.

In the present disclosure, the specific surface area and pore volume of the porous carbon are measured by the Brunauer-Emmett-Teller (BET) test method, for example, using a Tri Star II specific surface area analyzer.

The negative electrode material can be prepared by the following method:
a) placing the porous carbon material in a chemical vapor deposition furnace, then introducing silane gas, and raising temperature to cause silane to crack and produce silicon particles that deposit in the pores of the porous carbon to obtain silicon-carbon composite particles as the core; and
b) placing the silicon-carbon composite particles in the chemical vapor deposition furnace, continuing to introduce acetylene gas, and raising temperature to cause the acetylene gas to crack and produce carbon particles that deposit on the surface of the silicon-carbon particles to form a carbon layer.

The porous carbon material can be a commercial porous carbon material, such as activated carbon purchased from Aladdin.

In one embodiment, the silane gas is selected from one or more of monosilane, trichlorosilane, trifluorosilane.

In one embodiment, the cracking conditions for the silane include: a temperature ranging from 400° C. to 800° C. (e.g., 400° C., 500° C., 600° C., 700° C., 800° C.) and a time ranging from 6 h to 10 h (e.g., 6 h, 7 h, 8 h, 9 h, 10 h).

In one embodiment, the cracking conditions for the acetylene gas include: a temperature ranging from 600° C. to 1,000° C. (e.g., 600° C., 700° C., 800° C., 900° C., 1,000° C.) and a time ranging from 30 min to 2 h (e.g., 30 min, 1 h, 1.5 h, 2 h).

The second aspect of the present disclosure provides a negative electrode plate, which includes a negative electrode current collector and a negative electrode active material layer coated on at least one side surface of the negative electrode current collector, and the negative electrode active material layer includes the negative electrode material according to the first aspect of the present disclosure.

Materials of the negative electrode plate other than the negative electrode material in the negative electrode active material layer can be used in a manner conventional in the art, all of which can achieve the effects of higher specific capacity and higher initial coulombic efficiency.

According to a specific embodiment, the median particle size Dv50 of the negative electrode material ranges from 1 μm to 20 μm (e.g., 1 μm, 3 μm, 5 μm, 8 μm, 10 μm, 12 μm, 15 μm, 17 μm, 20 μm).

In one embodiment, the median particle size Dv50 of the negative electrode material ranges from 3 μm to 15 μm.

In the present disclosure, the median particle size Dv50 of the negative electrode material is measured by a laser particle size test method, for example, using a Malvern particle size tester. The test steps are as follows: dispersing the negative electrode material in deionized water containing a dispersant (such as nonylphenol polyoxyethylene ether, with a content ranging from 0.02 wt % to 0.03 wt %) to form a mixture, subjecting the mixture to ultrasonication for 2 min, and then placing it into the Malvern particle size tester for testing.

In one embodiment, the specific surface area of the negative electrode material is 0.1 m²/g-25 m²/g (e.g., 0.1 m²/g, 0.5 m²/g, 1 m²/g, 5 m²/g, 10 m²/g, 15 m²/g, 20 m²/g, 25 m²/g).

In one embodiment, the specific surface area of the negative electrode material ranges from 0.5 m²/g to 20 m²/g.

In the present disclosure, the specific surface area of the negative electrode material can be measured by the Brunauer-Emmett-Teller (BET) test method, for example, using a Tri Star II specific surface area analyzer.

In one embodiment, the negative electrode active material layer further includes graphite.

In one embodiment, the graphite is artificial graphite and/or natural graphite.

According to a specific embodiment, based on the total weight of the negative electrode material and the graphite, the weight content of the negative electrode material ranges from 3 wt % to 90 wt % (e.g., 3 wt %, 5 wt %, 10 wt %, 20 wt %, 30 wt %, 40 wt %, 50 wt %, 60 wt %, 70 wt %, 80 wt %, 90 wt %), and the weight content of the graphite ranges from 10 wt % to 97 wt % (e.g., 10 wt %, 20 wt %, 30 wt %, 40 wt %, 50 wt %, 60 wt %, 70 wt %, 80 wt %, 90 wt %, 95 wt %, 97 wt %).

In one embodiment, based on the total weight of the negative electrode material and the graphite, the weight content of the negative electrode material ranges from 5 wt % to 80 wt %, and the weight content of the graphite ranges from 20 wt % to 95 wt %.

In one embodiment, the negative electrode active material layer includes a conductive agent and a binder.

In one embodiment, the conductive agent includes one or more of carbon black (SuperP), acetylene black, Ketjenblack, carbon fiber, single-walled carbon nanotube, or multi-walled carbon nanotube.

In one embodiment, the binder includes one or more of carboxymethyl cellulose, sodium carboxymethyl cellulose, lithium carboxymethyl cellulose, hydroxypropyl cellulose, diacetyl cellulose, polyethylene, polyvinyl alcohol, polyvinyl chloride, polyvinyl fluoride, polyvinyl pyrrolidone, polytetrafluoroethylene, polypropylene, styrene-butadiene rubber, or epoxy resin.

In one embodiment, the negative electrode current collector includes one or more of copper foil, carbon-coated copper foil, or perforated copper foil.

In one embodiment, based on the total weight of the negative electrode active material layer, the sum of the weight contents of the negative electrode material and the graphite ranges from 50 wt % to 99.5 wt % (e.g., 50 wt %, 55 wt %, 60 wt %, 65 wt %, 70 wt %, 75 wt %, 80 wt %, 85 wt %, 90 wt %, 95 wt %, 99 wt %, 99.5 wt %), the weight content of the conductive agent ranges from 0.1 wt % to 20 wt % (e.g., 0.1 wt %, 0.3 wt %, 0.5 wt %, 1 wt %, 3 wt %, 5 wt %, 7 wt %, 10 wt %, 12 wt %, 15 wt %, 20 wt %), and the weight content of the binder ranges from 0.4 wt % to 30 wt % (e.g., 0.4 wt %, 0.5 wt %, 1 wt %, 3 wt %, 5 wt %, 7 wt %, 10 wt %, 12 wt %, 15 wt %, 20 wt %, 25 wt %, 30 wt %).

In one embodiment, based on the total weight of the negative electrode active material layer, the sum of the weight contents of the negative electrode material and the graphite ranges from 70 wt % to 99 wt % (e.g., 70 wt %, 75 wt %, 80 wt %, 85 wt %, 90 wt %, 95 wt %, 99 wt %), the weight content of the conductive agent ranges from 0.5 wt % to 15 wt % (e.g., 0.5 wt %, 1 wt %, 3 wt %, 5 wt %, 7 wt %, 10 wt %, 12 wt %, 15 wt %), and the weight content of the binder ranges from 0.5 wt % to 15 wt % (e.g., 0.5 wt %, 1 wt %, 3 wt %, 5 wt %, 7 wt %, 10 wt %, 12 wt %, 15 wt %).

In one embodiment, based on the total weight of the negative electrode active material layer, the weight contents of the negative electrode material and the graphite range from 80 wt % to 98 wt %, the weight content of the conductive agent ranges from 1 wt % to 10 wt %, and the weight content of the binder ranges from 1 wt % to 10 wt %.

The negative electrode plate can be prepared by a method known in the conventional technology, or can be prepared by the following manner:
mixing the negative electrode material, the graphite, the conductive agent, and the binder in deionized water to obtain a negative electrode slurry, coating the negative electrode slurry on at least one side surface of the negative electrode current collector, drying, slicing, transferring to a vacuum oven for drying, and finally rolling and cutting.

In one embodiment, the drying temperature ranges from 80° C. to 120° C.

In one embodiment, the drying conditions include: a temperature ranging from 80° C. to 120° C., a time ranging from 8 h to 12 h.

Since the negative electrode plate of the present disclosure includes the negative electrode active material layer of the negative electrode material of the present disclosure, the specific capacity and the initial coulombic efficiency are improved.

The third aspect of the present disclosure provides a battery, the negative electrode plate of which is the negative electrode material of the first aspect of the present disclosure.

Materials of the battery other than the negative electrode plate can be used in a manner conventional in the conventional technology, all of which can achieve the effects of better rate performance, higher cycling capacity retention rate, and lower expansion rate.

The battery can be a lithium-ion battery.

In one embodiment, the battery includes a positive electrode plate, an electrolyte solution, and a separator.

The positive electrode plate can be a conventional positive electrode plate in the conventional technology. For example, the positive electrode plate includes a positive electrode current collector and a positive electrode active material layer coated on at least one side surface of the positive electrode current collector, and the positive electrode active material layer includes a positive electrode material.

In one embodiment, the positive electrode current collector includes one or more of aluminum foil, carbon-coated aluminum foil, or perforated aluminum foil.

In one embodiment, the positive electrode material includes one or more of lithium iron phosphate, lithium manganese phosphate, lithium vanadium phosphate, lithium iron silicate, lithium mcobaltate, nickel-cobalt-manganese ternary material, nickel-manganese binary material, cobalt-manganese binary material, nickel-cobalt binary material, lithium manganate, or lithium-rich manganese-based material.

The electrolyte solution can be a conventional electrolyte solution in the conventional technology. For example, the electrolyte solution is a non-aqueous electrolyte solution, and the electrolyte solution includes a carbonate solvent and a lithium salt.

In one embodiment, the carbonate solvent includes one or more of ethylene carbonate (EC), propylene carbonate (PC), diethyl carbonate (DEC), fluoroethylene carbonate (FEC), dimethyl carbonate (DMC), or ethyl methyl carbonate (EMC).

In one embodiment, the lithium salt includes one or more of LiPF₆, LiBF₄, LiSbF₆, LiClO₄, LiCF₃SO₃, LiAlO₄, LiAlCl₄, Li(CF₃SO₂)₂N, LiBOB, or LiDFOB.

The separator can be a conventional separator in the conventional technology. For example, the separator includes polyethylene and/or polypropylene.

The casing of the battery can include one of aluminum-plastic film, aluminum alloy, and stainless steel.

Since the battery of the present disclosure contains the negative electrode plate of the present disclosure, the rate performance and cycling capacity retention rate of the battery are improved, and the expansion of the battery is reduced.

The present disclosure will be described in detail below through embodiments. The embodiments described herein are only a part of the embodiments of the present disclosure, rather than all embodiments. All other embodiments obtained by those of ordinary skill in the conventional technology without creative efforts based on the embodiments of the present disclosure shall fall within the protection scope of the present disclosure.

The following embodiments are used to illustrate the negative electrode material and negative electrode plate of the present disclosure.

### Example 1

### (1) Component Preparation

Porous carbon: 30 g, with a most probable pore size of 2 nm, pore volume of 0.65 cm³/g, median particle size of 6 μm, and specific surface area of 1200 m²/g;

Silane gas: trichlorosilane,monosilane;

Acetylene;

Negative electrode material: 50 parts by weight (where the median particle size of the negative electrode material is 6 μm, and the specific surface area of the negative electrode material is 2.5 m²/g);

Graphite: 46.5 parts by weight of artificial graphite;

Conductive agent: 0.3 part by weight of Super P;

Binder: 1.6 parts by weight of sodium carboxymethyl cellulose and 1.6 parts by weight of styrene-butadiene rubber;

Negative electrode current collector: copper foil with a thickness of 8 μm.

### (2) Preparation of Negative Electrode Material

The porous carbon was placed in a chemical vapor deposition furnace, and monosilane gas with a flow rate of 300 sccm was introduced. The temperature was then raised to 500° C. to cause the monosilane to crack, and the cracking time was controlled for 8 h. After completion, the introduction of monosilane was stopped, the temperature was raised to 700° C., acetylene gas with a flow rate of 100 sccm was introduced, and the acetylene cracking time was controlled for 1 h.

### (3) Preparation of Negative Electrode Plate

The prepared negative electrode material, artificial graphite, sodium carboxymethyl cellulose, styrene-butadiene rubber, and Super P were mixed, deionized water was added, and a negative electrode slurry was obtained under a vacuum mixer. The negative electrode slurry was uniformly coated on both side surfaces of the negative electrode current collector, and the areal density of the negative electrode slurry coated on the surface of the negative electrode current collector was 11.0 mg/cm². The negative electrode current collector coated with the negative electrode slurry was transferred to an oven at 80° C. for drying for 12 h, followed by rolling and cutting to obtain a negative electrode plate.

### Example 2

This example was performed with reference to Example 1, except that the cracking conditions of the silane were adjusted to a temperature of 700° C. and a time of 10 h, and the cracking conditions of the acetylene gas were adjusted to a temperature of 800° C., as specifically shown in Table 1.

### Example 3

This example was performed with reference to Example 1, except that the silane gas was adjusted to trichlorosilane and the cracking conditions of the silane were adjusted to a temperature of 520° C., as specifically shown in Table 1.

### Example 4

This example was performed with reference to Example 1, except that the pore size of the porous carbon was adjusted to 9 nm, as specifically shown in Table 1.

### Example 5

This example was performed with reference to Example 1, except that the pore volume of the porous carbon was adjusted to 0.4 cm³/g, as specifically shown in Table 1.

### Example 6 Group

This group of examples is used to illustrate the influence of changing the median particle size of the porous carbon.

### Example 6a

This example was performed with reference to Example 1, except that the median particle size of the porous carbon was adjusted to 10 μm, as specifically shown in Table 1.

### Example 6b

This example was performed with reference to Example 1, except that the median particle size of the porous carbon was adjusted to 15 μm, as specifically shown in Table 1.

### Example 7

This example was performed with reference to Example 1, except that the specific surface area of the porous carbon was adjusted to 800 m²/g, as specifically shown in Table 1.

### Example 8 Group

This group of examples is used to illustrate the influence of changing the cracking conditions of the silane, which causes changes in at least one of the median particle size of the silicon particles, the full width at half maximum B of the diffraction peak, and the ratio x of the weight content of silicon element to the weight content of carbon element.

### Example 8a

This example was performed with reference to Example 1, except that the cracking temperature of the silane was adjusted to 1000° C., as specifically shown in Table 1.

### Example 8b

This example was performed with reference to Example 1, except that the cracking time of the silane was adjusted to 16 h, as specifically shown in Table 1.

### Example 8c

This example was performed with reference to Example 1, except that the cracking time of the silane was adjusted to 1 h, as specifically shown in Table 1.

### Example 9 Group

This group of examples is used to illustrate the influence of changing the cracking conditions of the acetylene gas, which causes changes in at least one of the thickness of the carbon layer, the full width at half maximum B of the diffraction peak, and the ratio x of the weight content of silicon element to the weight content of carbon element.

### Example 9a

This example was performed with reference to Example 1, except that the cracking temperature of the acetylene gas was adjusted to 1500° C., as specifically shown in Table 1.

### Example 9b

This example was performed with reference to Example 1, except that the cracking time of the acetylene gas was adjusted to 5 h, as specifically shown in Table 1.

### Example 9c

This example was performed with reference to Example 1, except that the cracking time of the acetylene gas was adjusted to 0.3 h, as specifically shown in Table 1.

### Comparative Example 1

This comparative example was performed with reference to Example 1, except that acetylene was not introduced for cracking during the preparation of the negative electrode material, as specifically shown in Table 1.

### Comparative Example 2

30 g of commercial 100 nm silicon particle powder was placed in a chemical vapor deposition furnace, the temperature was raised to 700° C., acetylene gas with a flow rate of 100 sccm was introduced, and the acetylene cracking time was controlled for 1 h.

TABLE 1

| | porous carbon | | | | | | | | |
|---|---|---|---|---|---|---|---|---|---|
| | most | | | specific | Dv50 of | thickness | | | |
| | probable | | pore | surface | silicon | of the | | | weight- |
| | pore | Dv50/ | volume | area | particle | carbon | | | loss |
| | size/nm | μm | cm³/g | m²/g | 0.3 cm³/g/nm | layer/nm | B | x | peak |
| Example 1 | 2 | 6 | 0.65 | 1200 | 500 | 7 | 0.89° | 1.32 | exist |
| Example 2 | * | * | * | * | 1500 | 9 | 0.51° | 1.54 | exist |
| Example 3 | * | * | * | * | 450 | * | 1.13° | 1.22 | exist |
| Example 4 | 9 | * | * | * | 1900 | 6 | 0.39° | 1.37 | exist |
| Example 5 | * | * | 0.4 | 400 | 400 | 8 | 0.44° | 0.42 | exist |
| Example 6a | * | 10 | * | * | 2700 | 5 | 0.92° | 1.17 | exist |
| Example 6b | * | 15 | * | * | 3500 | 4 | 0.73° | 1.02 | exist |
| Example 7 | * | * | 0.55 | 800 | 350 | 7 | 1.01° | 0.99 | exist |
| Example 8a | * | * | * | * | 5500 | 7 | 0.37° | 1.74 | exist |
| Example 8b | * | * | * | * | 6200 | 6 | 0.58° | 2.53 | exist |
| Example 8c | * | * | * | * | 50 | 6 | 8.03° | 0.48 | exist |
| Example 9a | * | * | * | * | 5600 | 8 | 0.39° | 0.74 | exist |
| Example 9b | * | * | * | * | 4700 | 9 | 0.52° | 2.51 | exist |
| Example 9c | * | * | * | * | 1500 | 2 | 1.92° | 1.45 | not |
| | | | | | | | | | exist |
| Comparative | * | * | * | * | 100 | 0 | 2.05° | 1.56 | not |
| Example 1 | | | | | | | | | exist |
| Comparative | — | — | — | — | 108 | 4 | 0.15° | 4.93 | exist |
| Example 2 | | | | | | | | | |

* indicates the same as Example 1.

### Preparation Example

(1) Button-Type Half-Cells were Prepared from the Materials Obtained in the Examples and Comparative Examples According to the Following Procedures:
1) the negative electrode material, artificial graphite, Super P, sodium carboxymethyl cellulose, and styrene-butadiene rubber were mixed at a weight ratio of 50:46.5:0.3:1.6:1.6, deionized water was added, and the mixture was uniformly mixed under a vacuum mixer to obtain a negative electrode slurry;
2) the negative electrode slurry was coated on a copper foil, dried in an oven at 80° C., and then transferred to a vacuum oven at 100° C. for drying for 12 h to obtain a negative electrode plate with an areal density of approximately 6.0 mg/cm²;
3) in a dry environment, the negative electrode plate was rolled at a compaction density of approximately 1.3 g/cm³, and then punched into negative electrode discs with a diameter of 12 mm using a punching machine;
4) in a glove box, using the negative electrode disc as the working electrode, a metallic lithium sheet as the counter electrode, a polyethylene separator with a thickness of 20 μm as the isolation membrane, an electrolyte solution was added to assemble a button-type half-cell.
   (2) Batteries were Prepared from the Materials Obtained in the Examples and Comparative Examples According to the Following Procedures:

### 1) Preparation of Positive Electrode Plate

Lithium cobaltate (LCO), polyvinylidene fluoride (PVDF), acetylene black, and carbon nanotubes (CNTs) were mixed at a mass ratio of 96:2:1.5:0.5, N-methylpyrrolidone was added, and the mixture was stirred under a vacuum mixer until a uniform positive electrode slurry was formed. The positive electrode slurry was uniformly coated on an aluminum foil with a thickness of 12 μm. The coated aluminum foil was baked in an oven, then transferred to an oven at 120° C. for drying for 8 h, followed by rolling and cutting to obtain the required positive electrode plate. The size of the positive electrode plate was smaller than that of the negative electrode plate, and the reversible capacity per unit area of the positive electrode plate was 4% lower than that of the negative electrode plate.

### 2) Preparation of Negative Electrode Plate

The negative electrode plates obtained in the above examples and comparative examples were used respectively.

### 3) Separator

A polyethylene separator with a thickness of 8 μm was selected.

### 4) Preparation of Lithium-Ion Battery

The positive electrode plate in step 1), the separator in step 3), and the negative electrode plate in step 2) were stacked in sequence, ensuring that the separator was between the positive and negative electrode plates to play an isolating role, and then a bare cell was obtained by winding. The bare cell was placed in an aluminum-plastic film casing, the electrolyte solution was injected into the dried bare cell, and the required battery was prepared through processes such as vacuum packaging, standing, formation, shaping, and sorting.

### Test Examples

### (1) Specific Capacity and Initial Coulombic Efficiency Test for Button-Type Half-Cell

The performance of the button-type half-cell was tested using a LAND test system at a test temperature of 25° C. Specifically:
lithium intercalation was performed at a current of 0.1 mA to 0.005 V, followed by a 10-min rest; lithium intercalation was then performed at a current of 0.05 mA to 0.005 V, followed by a 10-min rest; lithium deintercalation was performed at a current of 0.1 mA to 1.5 V. The first charge-discharge capacity was obtained, the specific capacity of the negative electrode plate was calculated by dividing the first charge-discharge capacity by the mass of the negative electrode material in the negative electrode disc, and the initial coulombic efficiency of the negative electrode plate was calculated by dividing the first deintercalation capacity by the first intercalation capacity. The results are shown in Table 2.

### (2) Performance Test for Lithium-Ion Battery

The battery was tested using a LAND test system at a test temperature of 25° C.

### (2.1) Nominal Capacity Test

Charging was performed at 0.7C constant current to 4.45V, followed by constant voltage charging to 0.05C, a 10-min rest, and discharging at 0.2C to 3.0V to obtain the discharge capacity, which was recorded as the nominal capacity. The results are shown in Table 2.

### (2.2) Energy Density Test

The energy of the battery was calculated by multiplying the nominal capacity by the average discharge voltage, and the energy density of the battery was calculated by dividing the energy by the volume of the battery. The results are shown in Table 2.

### (2.3) Capacity Retention Rate Test

Charging was performed at 1.5C constant current to 4.45V, followed by constant voltage charging to 0.05C, a 10-min rest, discharging at 1C to 3.0V, and a 10-min rest. This charge-discharge cycle was performed, with the highest discharge capacity in the first three weeks taken as the initial capacity of the battery. The capacity retention rate of the battery was recorded as the ratio of the capacity after 500 cycles to the initial capacity. The results are shown in Table 2.

### (2.4) Volume Expansion Rate Test

Charging was performed at 0.7C constant current to 3.85V, followed by constant voltage charging to 0.01C, and the thickness of the battery at this time was measured as the initial thickness. The thickness of the battery after 500 cycles was measured, and the volume expansion rate of the battery was calculated as the difference between this thickness and the initial thickness divided by the initial thickness. The results are shown in Table 2.

### (2.5) Determination of the Ratio of 1C Discharge Capacity to 0.2C Discharge Capacity

Charging was performed at 0.7C constant current to 4.45V, followed by constant voltage charging to 0.05C, a 10-min rest, discharging at 0.2C to 3.0V, and a 10-min rest, with this charge-discharge cycle performed for three weeks. Subsequently, charging was performed at 0.7C constant current to 4.45, followed by constant voltage charging to 0.05C, a 10-min rest, discharging at 1C to 3.0V, and a 10-min rest, with this charge-discharge cycle performed for another three weeks. The highest discharge capacity in the first three weeks was taken as the 0.2C discharge capacity, and the highest discharge capacity in the subsequent three weeks was taken as the 1C discharge capacity. The results are shown in Table 2.

The obtained results are recorded in Table 2.

TABLE 2

| | | | | | capacity | volume | Ratio of |
|---|---|---|---|---|---|---|---|
| | specific | Initial | nominal | energy | retention | expansion | discharge |
| | capacity | coulombic | capacity | density | rate after | rate after | capacity at 1 C |
| | (mAh/g) | efficiency | (mAh) | (Wh/L) | 500 cycles | 500 cycles | to that at 0.2 C |
| Example 1 | 1233.3 | 91.92% | 3554 | 825 | 91.13% | 8.08% | 98.52% |
| Example 2 | 1235.9 | 91.68% | 3556 | 827 | 91.02% | 8.74% | 98.37% |
| Example 3 | 1237.6 | 91.71% | 3557 | 828 | 91.49% | 8.31% | 98.14% |
| Example 4 | 1213.4 | 90.53% | 3547 | 819 | 86.96% | 9.92% | 96.05% |
| Example 5 | 1140.1 | 88.03% | 3261 | 780 | 85.06% | 9.99% | 95.01% |
| Example 6a | 1209.3 | 90.44% | 3536 | 807 | 90.88% | 9.04% | 95.36% |
| Example 6b | 1081.7 | 88.37% | 3201 | 746 | 85.61% | 10.10% | 94.90% |
| Example 7 | 1192.2 | 90.09% | 3502 | 801 | 90.74% | 8.03% | 98.21% |
| Example 8a | 1402.8 | 87.05% | 3588 | 834 | 85.70% | 11.46% | 95.82% |
| Example 8b | 1398.1 | 87.47% | 3581 | 832 | 84.55% | 12.23% | 94.77% |
| Example 8c | 1087.0 | 86.55% | 3219 | 751 | 80.23% | 13.08% | 93.72% |
| Example 9a | 1232.9 | 87.58% | 3409 | 794 | 84.92% | 12.33% | 95.16% |
| Example 9b | 1231.8 | 86.99% | 3462 | 799 | 81.47% | 12.64% | 95.63% |
| Example 9c | 1247.5 | 85.24% | 3527 | 821 | 79.81% | 13.24% | 92.09% |
| Comparative | 1250.6 | 80.29% | 3521 | 820 | 52.74% | 21.91% | 90.52% |
| Example 1 | | | | | | | |
| Comparative | 1304.7 | 83.16% | 3533 | 823 | 26.55% | 30.72% | 88.41% |
| Example 2 | | | | | | | |

It can be seen from Table 2 that, by comparing the comparative examples and examples, the initial coulombic efficiency of the negative electrode plates prepared from the negative electrode materials of the examples is improved, the capacity retention rate of the batteries prepared from the negative electrode materials of the examples is significantly improved, the volume expansion rate is significantly reduced, and the ratio of the discharge capacity at 1C to that at 0.2C is increased. This indicates that the negative electrode material of the present disclosure, as well as the negative electrode plates and batteries including the negative electrode material, improve the initial coulombic efficiency of the negative electrode plates, improve the cycling capacity retention rate and rate performance of the batteries, and reduce the volume expansion rate of the batteries by improving the structural stability of the negative electrode material.

The preferred embodiments of the present disclosure have been described in detail above, however, the present disclosure is not limited thereto. Within the technical concept of the present disclosure, various simple modifications can be made to the technical solutions of the present disclosure, including any other suitable combination of various technical features. These simple modifications and combinations should also be regarded as the disclosed content of the present disclosure and all fall within the protection scope of the present disclosure.

What is claimed is:

1. A negative electrode material, wherein the negative electrode material has a core-shell structure, the shell of the negative electrode material comprises a carbon layer, and a core of the negative electrode material comprises porous carbon and silicon particles distributed in the pores of the porous carbon, and the negative electrode material has a weight-gain peak between 400° C. and 900° C. on a derivative thermogravimetric curve of the negative electrode material.

2. The negative electrode material according to claim 1, wherein the negative electrode material has a weight-gain peak between 400° C. and 900° C. and at least one weight-loss peak in a temperature range lower than the weight-gain peak on the derivative thermogravimetric curve of the negative electrode material; and/or,
a pore volume of the porous carbon is greater than 0.3 cm³/g.

3. The negative electrode material according to claim 2, wherein the pore volume of the porous carbon is greater than 0.5 cm³/g.

4. The negative electrode material according to claim 1, wherein in an X-ray powder diffraction test of the negative electrode material, there is a diffraction peak in the range of 2θ=28.4° 0.5°, a half-height width of this diffraction peak is denoted as B in terms of 2θ degrees, and B satisfies 0.3°≤B≤10°.

5. The negative electrode material according to claim 4, wherein B satisfies 0.5°≤B≤6°.

6. The negative electrode material according to claim 1, wherein the pore size of the porous carbon is less than 10 nm, and/or, a median particle size Dv50 of the silicon particles ranges from 0.1 nm to 10000 nm.

7. The negative electrode material according to claim 1, wherein in the negative electrode material, a ratio x of the weight content of silicon element to the weight content of carbon element satisfies 0.33≤x≤3.

8. The negative electrode material according to claim 7, wherein the ratio x of the weight content of silicon element to the weight content of carbon element satisfies 0.5≤x≤2.

9. The negative electrode material according to claim 1, wherein a thickness of the carbon layer ranges from 1 nm to 15 nm.

10. The negative electrode material according to claim 9, wherein the thickness of the carbon layer ranges from 2 nm to 10 nm.

11. The negative electrode material according to claim 1, wherein the median particle size Dv50 of the porous carbon ranges from 1 μm to 15 μm; and/or,
the specific surface area of the porous carbon ranges from 300 m²/g to 1800 m²/g.

12. A method for preparing the negative electrode material according to claim 1, comprising:
a) placing the porous carbon material in a chemical vapor deposition furnace, then introducing silane gas, and raising temperature to cause silane to crack and produce silicon particles that deposit in the pores of the porous carbon to obtain silicon-carbon composite particles as the core; and
b) placing the silicon-carbon composite particles in the chemical vapor deposition furnace, continuing to introduce acetylene gas, and raising temperature to cause the acetylene gas to crack and produce carbon particles that deposit on the surface of the silicon-carbon particles to form a carbon layer.

13. The method for preparing the negative electrode material according to claim 12, wherein the silane gas is selected from one or more of monosilane, trichlorosilane, or trifluorosilane; and/or,
the cracking conditions for the silane comprise: a temperature ranging from 400° C. to 800° C. and a time ranging from 6 h to 10 h; and/or,
the cracking conditions for the acetylene gas comprise: the temperature ranging from 600° C. to 1,000° C. and the time ranging from 30 min to 2 h.

14. A negative electrode plate, comprising a negative electrode current collector and a negative electrode active material layer coated on at least one side surface of the negative electrode current collector, wherein the negative electrode active material layer comprises the negative electrode material according to claim 1.

15. The negative electrode plate according to claim 14, wherein the median particle size Dv50 of the negative electrode material ranges from 1 μm to 20 μm;
and/or, the specific surface area of the negative electrode material ranges from 0.1 m²/g to 25 m²/g.

16. The negative electrode plate according to claim 14, wherein the negative electrode active material layer further comprises graphite; based on the total weight of the negative electrode material and the graphite, a weight content of the negative electrode material ranges from 3 wt % to 90 wt %, and a weight content of the graphite ranges from 10 wt % to 97 wt %.

17. A battery, comprising the negative electrode material according to claim 1.

18. The battery according to claim 17, wherein the battery is a lithium-ion battery.
